(19) United States
(12) Patent Application Publication
(10) Pub. No.: US 2014/0261216 A1
(43) Pub. Date: Sep. 18, 2014

(54) FISH TANK ILLUMINATION SYSTEM

(71) Applicants: Gary Fosburg, Grass Valley, CA (US); Mark Fisher, Grass Valley, CA (US)

(72) Inventors: Gary Fosburg, Grass Valley, CA (US); Mark Fisher, Grass Valley, CA (US)

(21) Appl. No.: 14/215,942

(22) Filed: Mar. 17, 2014

Related U.S. Application Data
(60) Provisional application No. 61/794,159, filed on Mar. 15, 2013.

(51) Int. Cl. A01K 63/06

(52) U.S. Cl. CPC A01K 63/06
USPC 119/267

(57) ABSTRACT

A fish tank illumination system including an external light unit placed against a transparent panel on a fish tank filled with water, and a decorative element submerged and placed inside the fish tank. The external light unit includes a light source producing a narrow light beam through the transparent panel. The decorative element or adapter is mounted on the inside surface of the transparent panel opposite the external light unit. The decorative element may include transparent or translucent objects or internal cavities illuminated by the light from the external light unit. The adapter may be used to receive the light from the external light unit or used to mount the decorative element on the transparent panel. Magnetic elements in the external light unit and on the decorative elements are used to align and hold the light unit and decorative element or the adapter on opposite sides of the transparent panel.

This utility patent application is based upon and claims the filing date benefit of U.S. provisional patent application (Application No. 61/679,4159) filed on Mar. 15, 2013.

Notice is given that the following patent document contains original material subject to copyright protection. The copyright owner has no objection to the facsimile or digital download reproduction of all or part of the patent document, but otherwise reserves all copyrights.

### BACKGROUND OF THE INVENTION

1. Field of the Invention

This invention pertains to illumination systems for fish tanks and more particularly, to such systems that illuminate submerged decorative elements inside the fish tank using a light source located outside the tank.

2. Description of the Related Art

Glow rocks made of luminescent materials are commonly used in fish tanks to create visual effects that captivate viewers. Unfortunately, glow rocks provide little illumination for only short time periods.

Ornaments with internal lights that are submerged in the fish tank are also available that use a waterproof housing containing a light source, a lighting circuit, and a least one battery. The waterproof housing is relatively large and occupies space on the bottom of the tank. Plants and filters are often placed in front of the housing to hide them from view when standing in front of the tank. The waterproof housings typically include manual ON/OFF switches mounted on the sides that allows the operator to reach into the tank and selectively operate the light source. Because the internal lights are energized by batteries, the batteries must be replaced on a regular basis.

What is needed is a fish tank illuminating system that can be used with a standard fish tank with solid side and bottom panels that can be filled with water that positions the light source outside of the tank and allows the light from the light source to be transmitted through one of the panels into a decorative element located inside the tank and submerged in the water. Because the light source is located outside of the tank, the nature and number of light emitting bulbs may be used and the electrical energy source may be one or more batteries, a transformer or a 110 volt A.C power source.

### SUMMARY OF THE INVENTION

The above needs are met by the fish tank illumination system that includes an external light unit located outside a fish tank which is coupled to or contains a light source, and a decorative element which is separate from the light unit and located inside the fish tank. The system includes a light transferring apparatus that transmits light from the external light unit through a transparent panel on the tank and directly into the decorative element or to an adapter disposed on the inside surface of the fish tank. The decorative element includes light transmitting bores, transparent surfaces or other structures which are illuminated with light from the external light source. When operating, the light generated in the external light unit is narrowed and transmitted through the transparent panel and into the decorative element directly or via the adapter. When the fish tank is viewed from the front or sides, the light from the decorative element appears to be contained inside the decorative element thereby increasing viewer's curiosity and interest.

In one embodiment, the external light unit contains one or more LED bulbs configured to transmit a narrow beam of light generated by the LED bulbs through the transparent panel. In one embodiment, the decorative element is placed against the inside surface of the fish tank's transparent panel opposite the external light unit. The decorative element may be a hollow structure that is illuminated by the light from the external light unit or it may include optical fibers that transmit the light from the external light unit to specific bores, cavities or surfaces on the decorative element visible to an observer. In one embodiment, the external light unit may be attached or mounted on the external surface of a transparent panel on a fish tank. The decorative element is attached to the inside surface of the transparent panel directly opposite the external light unit. In one embodiment, the decorative element is the same size or slightly larger than the external light unit thereby partially hiding the external light unit. In some embodiments, an adapter is attached to the inside surface of the transparent panel directly opposite the external light unit. The adapter is connected to a fiber cable with one or more optical fibers that transmit light to the decorative element.

A decorative element or the adapter is placed inside the tank and against the inside surface of the transparent panel opposite the external light source. Magnetic elements are mounted on the external light unit and on the decorative element or on the adapter. The two magnetic elements align and hold the external light unit and the decorative element or adapter on opposite sides of the transparent panel. In the embodiment shown herein, the magnetic elements are flat circular magnets with the magnetic poles oriented in opposite directions so they are magnetically attracted together.

Because the decorative element or adapter are aligned on the transparent panel opposite the external light unit, light from the external light source shines directly into the decorative element or into the adapter. The decorative element may be hollow or it may include a fiber cable that receives and transmit the light to designated areas in the decorative element. When the adapter is used, it may connect to the decorative element to hold the decorative element on the transparent panel or it may include a fiber cable that extends to the decorative element located remotely from the adapter.

An optional mirror panel may be disposed between the external light unit and the outside surface of the transparent panel that reflects the image of the fish tank and hides the external light unit from view.

The external light unit is connected to batteries or an external electrical adapter. The external light unit may also include a manual ON/OFF switch, an illumination mode switch and a light intensity switch. The external light unit may also include an audio plug that enables audio signals to be delivered to the external light unit to change the light patterns to the decorative element.

### BRIEF DESCRIPTION OF THE DRAWINGS

FIG. 1 is a top perspective view of a fish tank filled with water with the fish tank illumination system assembled thereon.

FIG. 2 is a simple exploded view of the system and showing placing the external light unit on one flat panel on the tank.

FIG. 3 is a side elevational view of the external light unit and the intermediate adapter mounted on opposite side of a flat transparent panel on the fish tank with an optical cable containing optical fibers attached to the threaded neck on the intermediate adapter.

FIG. 4 is a perspective view of the adapter shown in FIG. 3 and showing a decorative element directly attached to the intermediate adapter.

FIG. 5 is a front plan view of the external light unit attached to a transformer and showing an optional mirror reflective panel being aligned and registered over the inside surface of the external housing unit.

FIG. 6 is a sectional side elevational view of the external housing unit.

FIG. 7 is a top plan view of the external housing unit.

FIG. 8 is a front plan view on a skull shaped decorative element with illuminated eyes and illuminated gold nuggets location in the mouth.

FIG. 9 is a front plan view of a pyramid shaped decorative element with a front illuminated area.

FIG. 10 is a front plan view on a plant shaped decorative element with illuminated elements at the ends of the branches.

FIG. 11 is a front plan view of a rock formation decorative element with illuminated elements on its flat surfaces.

FIG. 12 is an electrical schematic diagram of the fish tank illumination system.

### DESCRIPTION OF THE PREFERRED EMBODIMENT(S)

Referring to the accompanying FIGS. 1-12, there is shown a fish tank illumination system 10 that includes an external light unit 20 containing a light source 36. The external light unit 20 is configured for placement against the outside surface 94 of a transparent panel 92 on a fish tank 90. The system 10 also includes and an internal decorative element 50 configured to be submerged in the water 110 and either placed at a desired location inside the fish tank 90 and against the inside surface 93 of the transparent panel 92 opposite the external light unit 20. When operated, the light generated by the light source 36 inside the external light unit 20 is transmitted through the transparent panel 92 and delivered to the decorative element 50. The light is then transmitted to holes, cavities or light illuminated elements formed or mounted in the decorative element 50 increasing viewer curiosity and interest. Because the light source 36 is located inside the closed external light unit 20, waterproof issues, size issues and limited electrical power issues are solved.

FIG. 2 is a simple exploded view of the system 10 showing placement of the external light unit 20 on one flat transparent panel 92 on the tank 90. The external light unit 20 includes an outer housing 22 with a lower base 24 and an upper lid 28. An optional mirror reflective panel 48 with a coaxially aligned bore 49 is aligned and registered over the inside surface of the lower base 24. Formed on the lower base 24 is a central bore 25. Disposed inside the outer housing 22 is a printed circuit board (PCB 32) that has a plurality of perpendicularly aligned LED bulbs 36 mounted on its inside surface and aligned and registered with the central bore 25. The upper lid 28 is attached to the lower base 24 and includes a switch bore 29 through which a manual switch 40 extends. The switch 40 extends through the switch bore 29 on the outer housing 22 and connects to a switch circuit formed on the PCB 32.

As shown in FIGS. 2 and 3, disposed inside or mounted on the outside surface of the lower base 24 is a first magnetic element 45. In the embodiment presented, the first magnetic element 45 is a single flat ring structure located between the PCB 32 and the inside surface of the lower base 24. The first magnetic element 45 includes a center bore 46 that is coaxially aligned with the center bore 25 and receives the LED bulbs 36. It should be understood however, that the first magnet element 45 is not limited to a ring structure and may be mounted or attached to the outside surface of the lower base 24.

As mentioned above the system 10 also includes a decorative element (generally denoted by the reference number 50) that may be placed against the inside surface of the transparent panel 92 opposite the external light unit 20 or placed at a location in the tank 90 remote from the external light unit 20 The decorative element 50 includes an optical capable containing a plurality of fiber optics configured to transmit the light from the LED bulbs 36 to one or more holes, cavities or illuminating elements in the decorative element 50.

FIG. 3 is a side elevational view of the external light unit 50 and the intermediate adapter 60 mounted on flat transparent panel 92 of the fish tank and opposite the external light unit 20. The intermediate adapter 60 includes a flat disc body 62 with a second magnetic element 75 mounted on its inside surface magnetically attracted to the first magnetic element 46 mounted on the external light unit 20. The intermediate adapter 60 includes a perpendicularly aligned neck 65 with center bore that is coaxially aligned with a light bore form on the disk body 62. During operation, light generated by the LED bulbs 36 is transmitted into the center bore. The intermediate adapter 60 may include optional hang tags (see FIG. 4) that engage slots formed on the back surface of the decorative element 80. A separate optional optical cable 76 used with remote decorative elements or the optical cable 86 used with a hung decorative element 80 is attached to the neck 65. Light is then transmitted through the fiber optics 78 and 88 to the holes, cavities and illuminating elements in the decorative element.

Also shown in FIG. 3 is a switch panel 240 with switch 242 and a light intensity switch 2422 coupled to the PCB. The mode switch 242 is used to control whether the light produced by the external source unit controls the pre-programmed setting or whether the light produced by the external light unit 20 is controlled by an external audio device 300. The light intensity switch 244 is used to control the intensity of the light produced by the external light unit 20.

The first magnetic element 45 and the second magnetic element 75 are both magnets with their magnetic poles oriented on opposite flat surfaces. During assembly, the first magnetic element 45 and second magnetic element 75 are oriented so their magnetic poles are oriented in opposite directions thereby causing the magnetic elements 45, 75 to be magnetically attracted to each other when placed on opposite sides of the transparent panel 92. It should be understood that one of the magnetic elements 45 or 75 may be a strong magnet and the opposite magnetic element 45 or 75 is not a magnet but made of magnetic attractive material (ferritic stainless steel).

FIG. 5 is a front plan view of the external light unit 20 attached to a transformer 150 and showing an optional mirror reflective panel 48 being aligned and registered over the inside surface of the external housing unit 20. FIG. 5 also shows a female electrical plug 44 that receives an electrical male plug 152 that connects to the transformer 150. FIG. 5 also shows an optional electrical female connection port 46 that connects to a male connector 162 attached to one end of an electrical transfer wire 164. The transfer wire 164 includes a second male connector 162 that connects to the female electric plug 44 on a second external light unit 20 enabling several external light units 20 to be energized by one transformer 150.

FIG. 8 is a front plan view on a skull-shaped decorative element 120 with illuminated eyes 124 and illuminated gold nuggets 126 location in the mouth 122.

FIG. 9 is a front plan view of a pyramid-shaped decorative element 128 with a front illuminated area 130.

FIG. 10 is a front plan view on a plant-shaped decorative element 134 extending upward from the floor 91 of the fish tank with illuminated elements 136 at the ends of the branches.

FIG. 11 is a front plan view of a rock formation decorative element 140 positioned on the floor 91 of the fish tank with illuminated elements 142 on its flat surfaces.

FIG. 12 is an electrical schematic diagram 200 of the fish tank illumination system.

Shown in the diagram is an audio port 220 that connects to an external audio source generates audio signal delivered to the external light unit 20. When the external audio source is a cellular telephone 300, a software application 320 may be loaded to the working memory of the cellular telephone 300 that provides a menu page with controls for controlling the light pattern and light intensity.

In compliance with the statute, the invention described has been described in language more or less specific as to structural features. It should be understood however, that the invention is not limited to the specific features shown, since the means and construction shown, comprises the preferred embodiments for putting the invention into effect. The invention is therefore claimed in its forms or modifications within the legitimate and valid scope of the amended claims, appropriately interpreted under the doctrine of equivalents.

We claim:

1. A fish tank illumination system, comprising;
a. a fish tank filled with water with at least one transparent panel, said transparent panel includes an outside surface and an inside surface;
b. an external light unit located outside said transparent panel and configured to produce and transmit light through the transparent panel and into said fish tank;
c. a light source attached or located inside said external light unit;
d. a first magnetic element on said external light unit and positioned adjacent to said outside surface on said transparent panel;
e. a decorative element placed inside said fish tank; and,
f. a second magnetic element attached or coupled to said decorative element, said second magnetic element being sufficiently magnetically attracted to said first magnetic element so when said first magnetic element is placed against said outside surface of said transparent panel to hold and said second magnetic element is placed against said inside surface of said transparent panel and opposite said first magnetic element, said first magnetic element and said second magnetic element is securely held in position on opposite sides of said transparent panel.

2. The fish tank illumination system as recited in claim 1, further including an adapter with said second magnetic element is located which holds said adapter on opposite sides of said transparent panel.

3. The fish tank illumination system, as recited in claim 2, further including a fiber cable that extends from said adapter to said decorative element, the fiber cable includes at least one optical fiber that transmits light delivered to said adapter to said decorative element.

4. The fish tank illumination system, as recited in claim 1, further including a mirror layer located between said external housing unit and said outside surface of said transparent panel.

5. The fish tank illumination system, as recited in claim 1, wherein the light source is a plurality of LED bulbs.

6. The fish tank illumination system, as recited in claim 1, further including an external electricity source connected to said external housing unit to provide electricity to the LED bulbs.

7. The fish tank illuminated system, as recited in claim 1, wherein said decorative element simulates a human skull.

8. The fish tank illuminated system as recited in claim 7 wherein said skull includes eye sockets with illuminating elements.

9. The fish tank illuminated system as, recited in claim 7, further including a fiber cable that extends from said adapter to said human skill.

10. The fish tank illuminated system as recited in claim 1, wherein said decorative element simulates a miniature pyramid.

11. The fish tank illuminated system, as recited in claim 10, wherein said pyramid includes a front illuminated area.

12. The fish tank illuminated system as, recited in claim 10, further including a fiber cable that extends from said adapter to said pyramid.

13. The fish tank illuminated system, as recited in claim 1, wherein said decorative element is a simulated plant with branches and illuminated element mounted thereon.

14. The fish tank illuminated system as, recited in claim 13, further including a fiber cable that extends from said adapter to said simulated plant.

15. The fish tank illuminated system, as recited in claim 1, wherein said decorative element is a rock formation with illuminated elements.

16. The fish tank illuminated system as, recited in claim 15, further including a fiber cable that extends from said adapter to said rock formation.

17. The fish tank illuminating system as recited in claim 1, wherein said light source is located inside said external light unit.

18. The fish tank illuminated system as recited in claim 1, wherein said light source is a plurality of LED bulbs.

19. The fish tank illuminated system as recited in claim 1 further including a switch that turns said light source ON and OFF.
